(19) United States
(12) Patent Application Publication
(10) Pub. No.: US 2011/0159330 A1
(43) Pub. Date: Jun. 30, 2011

(54) BATTERY COVER ASSEMBLY FOR PORTABLE ELECTRONIC DEVICE

(75) Inventor: SHI-XU LIANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/766,214

(22) Filed: Apr. 23, 2010

(30) Foreign Application Priority Data
Dec. 30, 2009 (CN) 200910312819.0

(51) Int. Cl. H01M 2/10

(52) U.S. Cl. 429/97

(57) ABSTRACT

A portable electronic device includes a base, a battery cover and a resisting element. The base has a resisting portion. The battery cover attaches to the base. The resisting element elastically resists and is retained by the resisting portion.

### BACKGROUND

1. Technical Field

The exemplary disclosure generally relates to battery cover assemblies and, particularly, to a battery cover assembly and a portable electronic device utilizing the assembly.

2. Description of Related Art

Batteries are widely used in portable electronic devices, such as personal digital assistants (PDAs), mobile phones, and so on. Often, batteries are attachably received in the electronic device, and battery covers provided to connect with housings of the electronic devices to secure the batteries. Batteries are replaced by opening the battery covers when, for example, the batteries are damaged and/or dead (i.e. no longer rechargeable).

Although battery cover assemblies may be simple, the engagement between the battery cover and the housing of the mobile phone can be too strong to allow easy detachment thereof.

Therefore, there is room for improvement within the art.

### BRIEF DESCRIPTION OF THE DRAWINGS

Many aspects of the exemplary portable electronic device can be better understood with reference to the following drawings. The components in the drawings are not necessarily drawn to scale, the emphasis instead being placed upon clearly illustrating the principles of the battery cover assembly. Moreover, in the drawings, like reference numerals designate corresponding parts throughout the several views, in which:

FIG. 1 is an exploded, isometric view of an exemplary embodiment of a portable electronic device;

FIG. 2 is an isometric view of a battery of the portable electronic device;

FIG. 3 is an isometric view of a battery cover assembly for the portable electronic device;

FIG. 4 is an isometric view showing a latching module attached to a base of the portable electronic device; and

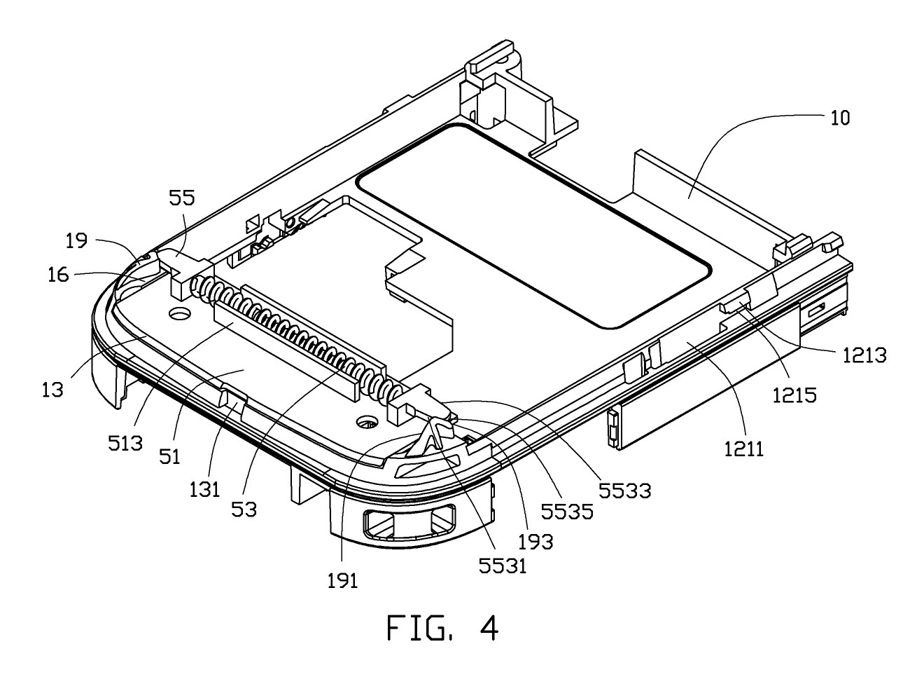

FIG. 5 is an assembled, isometric view of the portable electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

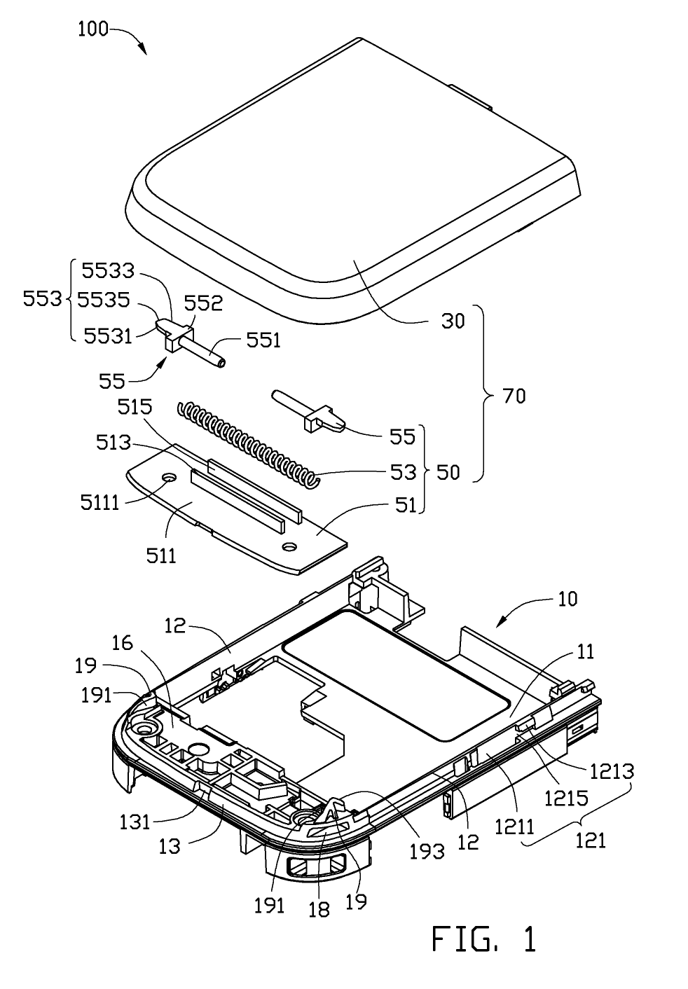

FIG. 1 shows an exemplary embodiment of a portable electronic device 100, such as a cellular phone or any electronic device where a battery is desirable. The portable electronic device 100 includes a base 10, a battery cover 30, and a latching module 50 connecting the battery cover 30 to the base 10.

The base 10 defines a battery compartment 11 configured for receiving a battery (not shown) to provide power for the portable electronic device 100. The battery compartment 11 is cooperatively defined by two opposite stepped sidewalls 12 and an end portion 13 connecting the two sidewalls 12. Each of the sidewalls 12 defines a latching hole 1211 and perpendicularly projects a retaining block 1213. The retaining block 1213 and the sidewalls 12 form a receiving space 1215 communicating with the latching hole 1211. The latching hole 1211, retaining block 1213, and receiving space 1125 cooperatively form a latching portion 121.

Referring also to FIG. 1, the end portion 13 defines a cutout 131 at approximately the middle thereof. The base 10 forms two receiving cavities 18 at the exterior corners where the end portion 13 and the sidewalls 12 connect to each other. The base 10 forms two resisting portions 19 at the interior corners where the end portion 13 and the sidewalls 12 connect to each other. Each of the resisting portions 19 includes a first resisting surface 191 adjacent to the end portion 13 and a second resisting surface 193 connected at an angle to the first resisting surface 191. Where the first and second surfaces 191,193 meet form a smooth corner. The two resisting portions 19 and the bottom surface of the battery compartment 11 cooperatively define a passage 16. The resisting portions 19 are positioned so that the corners thereof are near enough to each other to limit movement of two resisting elements 55 described later.

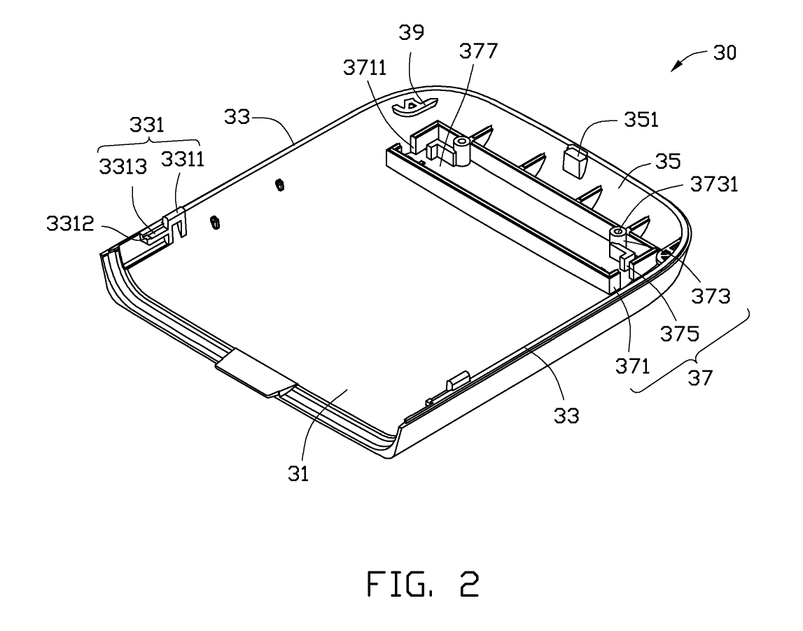

Referring to FIG. 2, the battery cover 30 includes a base plate 31, two side plates 33, and an end plate 35 with a latching projection 351 received in the cutout 131 of the base 10. The base plate 31, two side plates 33, and the end plate 35 cooperatively define an opening to secure the battery in the portable electronic device 100. Each of the side plates 33 forms a retaining portion 331 configured for latching with a corresponding latching portion 121 of the base 10. The retaining portion 331 of a given side plate 33 includes a latching protrusion 3311 perpendicularly extending to the base plate 31 and a resisting projection 3313 approximately parallel to the base plate 31 and connecting to the latching protrusion 3311. A hook 3132 projects upwards from the resisting protrusion 3311 at the end distant from the latching protrusion 3311.

The base plate 31 forms a positioning portion 37 at the end adjacent to the end plate 35. The positioning portion 37 includes a frame 371 laterally defining a opening 3711 at both sides, two positioning posts 373 each defining a positioning hole 3731 therein, and two positioning tabs 375 with L-shape. The two positioning tabs 375 and the frame 375 cooperatively form a receiving channel 377 communicating with the openings 3711. The battery cover 30 protrudes two latching tabs 39 each, at the intersection of a side plate 33 and the end plate 35, and received in a corresponding receiving cavity 18.

Referring back to FIG. 1, the latching module 50 includes a positioning element 51 configured for securing the latching module 50 to the battery cover 30, an elastic element 53 (e.g., a helical spring) configured for providing elastic force for the latching module 50, and two resisting elements 55 configured for latching with the resisting portions 19 of the base 10.

The positioning element 51 includes a panel 511 defining two through holes 5111 therein, two resisting walls 513 spaced projecting from the panel 511. The two resisting walls 513 face each other and cooperatively define a positioning slot 515 configured for receiving the elastic element 53.

Each of the resisting elements 55 includes a connecting portion 551 received in the elastic element 53, a resisting portion 552 connected to the connecting portion 551, and a resisting end 553. The resisting end 553 of a given resisting element 55 includes a first engaging surface 5531, a second engaging surface 5533, and a third engaging surface 5535 inclined to the first engaging surface 5531 and the second engaging surface 5533. The first, second and third engaging surfaces 5531, 5533 and 5535 are respectively inclined to the central axis of the connecting portion 551 and resists the first, second resisting surfaces 191 and 193 such that the resisting elements 55 retain the battery cover 30 to the base 10 in assembly and the movement is smooth when the resisting elements 55 slide along the resisting portions 19.

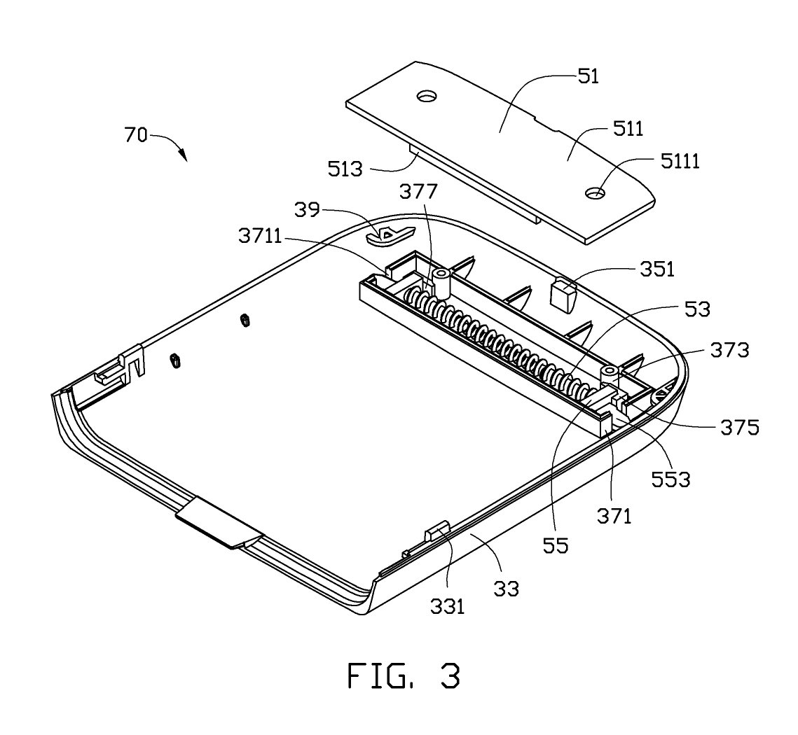

Referring to FIG. 3, during assembly of the portable 100, each connecting end 551 of the resisting elements 55 is received in the elastic element 53. The elastic element 53 is biased such that the two resisting elements 55 are received in the receiving channel 377 with the resisting ends 553 each passing through and extending out of a corresponding opening 3711. The positioning plate 51 is attached to the battery cover 30. The elastic element 53 is received in the positioning slot 515. The two through holes 5111 respectively align with the positioning holes 3731 of the positioning posts 373 such that the positioning plate 51 is fixed to the battery cover 30 via, e.g., a bolt. Thus, the latching module 50 is attached to the battery cover 30 to form a battery cover assembly 70.

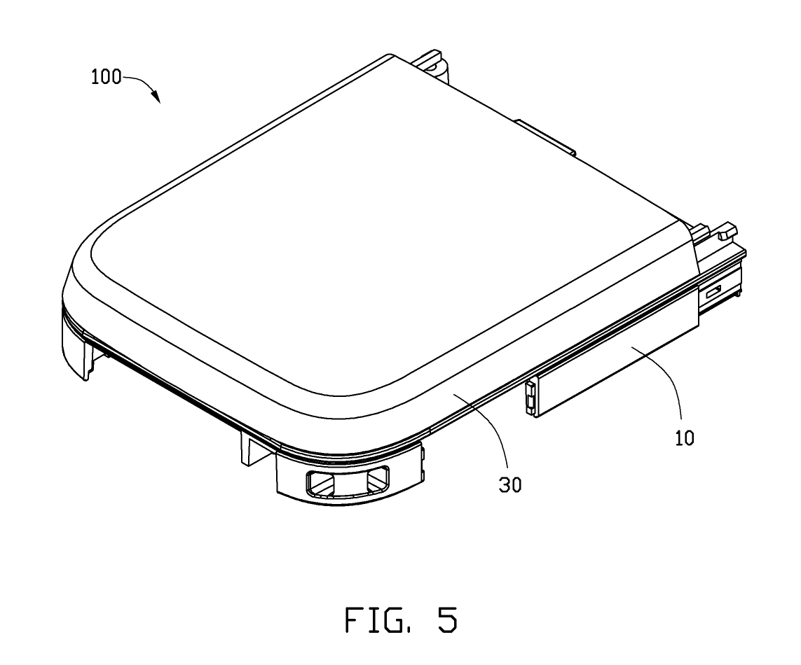

The battery cover assembly 70 is attached to the base 10. The battery cover 30 is attached to the base 10 such that the retaining portions 311 are respectively received in the latching holes 1211. The latching module 50 is received in the passage 16 and the second engaging surfaces 5533 each resist a corresponding first resisting surface 191 of resisting portion 19 such that the elastic element 53 is elastically deformed. The battery cover 30 is further pushed such that the hook 3312 of the resisting projection 3313 passes through the receiving space 1215 and resists the retaining block 1213. The second engaging surfaces 5533 each slide along a corresponding first resisting surface 191 and, after the third engaging surfaces 5535 passing the passage 16, the first engaging surfaces 5531 resist the second resisting surfaces 193 of the resisting portions 19 with the elastic force of the elastic element 53. The latching projection 351 is received in the cutout 131 of the end portion 13. And the latching tabs 39 each are received in a corresponding receiving cavity 18. Thus, the portable electronic device 100 is assembled, as shown in FIG. 5.

When a battery is to be replaced or installed, the battery cover 30 is pulled towards the end portion 13 of the base 10, the first engaging surface 5531 respectively resist and slide along the second resisting surfaces 193 such that the two resisting elements 55 move towards each other and elastically deform the elastic element 53. The battery cover 30 is further pulled, the third engaging surfaces 5535 pass the passage 16 such that the battery cover 30 can be removed from the base 10.

It is notable that the positioning element 51 can be omitted, and the elastic element 53 together with the resisting elements 55 are slidably attached to the battery cover 30. The third engaging surfaces 5535 of each resisting elements 55 can be omitted such that the first engaging surface 5531 is directly connected to the second engaging surface 5533. Further the elastic elements 53 can be divided into two and each integratively forms (e.g. via co-molding or melting) a resisting element 55. Moreover, the battery cover 30 can be rotatably attached to the base 10.

In the exemplary embodiment of the portable electronic device 100, the resisting elements 55 elastically deform the elastic element 53 during assembly/disassembly such that the portable electronic device 100 is easy to use.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device comprising:
a base having two resisting portions, the two resisting portions forming a passage;
a battery cover attached to the base;
a latching module attached the battery cover comprising:
an elastic element;
two resisting elements resisted by the elastic element, the resisting elements each resisting a corresponding resisting portion and retained by the resisting portions.

2. The portable electronic device as claimed in claim 1, wherein each of the resisting portions comprises a first resisting surface and a second resisting surface inclined to the first resisting surface.

3. The portable electronic device as claimed in claim 2, wherein each of the latching elements comprises a first engaging surface configured for resisting the second resisting surface during assembly and a second engaging surface engaging with the first resisting surface to retain the battery cover to the base.

4. The portable electronic device as claimed in claim 3, wherein each of the latching elements further comprises a third engaging surface inclined connecting to the first engaging surface and the second engaging surface.

5. The portable electronic device as claimed in claim 1, wherein the battery cover forms a positioning portion thereon, the positioning portion comprises a frame defining two openings configured for allowing the resisting elements to pass by and two positioning tabs cooperating with the frame forming a receiving channel, in which the elastic element is received.

6. The portable electronic device as claimed in claim 5, wherein the latching module further comprising a positioning element attached to the frame, the positioning element has a panel with two resisting wall, the panel and the two resisting wall cooperatively define a positioning slot where the elastic element is received.

7. The portable electronic device as claimed in claim 1, wherein the battery cover with the latching module is removably attached to the base.

8. The portable electronic device as claimed in claim 7, wherein the base forms two latching portions each comprising a latching hole, a retaining block, the retaining block cooperates with the base forms a receiving space, the battery cover forms two retaining portions each comprising a latching protrusion and a resisting projection with a hook, each of the latching protrusions is received in the latching hole, each of the hooks passes the receiving space and resists the retaining block.

9. The portable electronic device as claimed in claim 1, wherein the battery cover with the latching module is rotatably attached to the base.

10. A portable electronic device comprising:
a base having a resisting portion;
a battery cover attached to the base;
a resisting element the movement of which limited by the resisting portion.

11. The portable electronic device as claimed in claim 10, wherein the resisting portion comprises a first resisting surface and a second resisting surface inclined to the first resisting surface.

12. The portable electronic device as claimed in claim 11, wherein the latching element comprises a first engaging surface configured for resisting the second resisting surface during assembly and a second engaging surface engaging with the first resisting surface to retain the battery cover to the base.

13. The portable electronic device as claimed in claim 12, wherein the latching element further comprises a third engaging surface inclined connecting to the first engaging surface and the second engaging surface.

14. The portable electronic device as claimed in claim 10, wherein the battery cover forms a positioning portion thereon, the positioning portion comprises a frame defining an opening configured for allowing the resisting element to pass by and a positioning tab cooperating with the frame forming a receiving channel, in which the resisting element is received.

15. The portable electronic device as claimed in claim 14, wherein the battery cover with the latching module is removably attached to the base.

16. The portable electronic device as claimed in claim 15, wherein the base forms two latching portions each comprising a latching hole, a retaining block, the retaining block cooperates with the base forms a receiving space, the battery cover forms two retaining portions each comprising a latching protrusion and a resisting projection with a hook, each of the latching protrusions is received in the latching hole, each of the hooks passes the receiving space and resists the retaining block.

17. The portable electronic device as claimed in claim 10, wherein the battery cover with the latching module is rotatably attached to the base.

18. A battery cover assembly comprising:
a resisting element;
a battery cover with a positioning portion, the position having a frame with an opening, a resisting wall cooperating with the frame forming a receive channel, in which the resisting element is received.

19. The battery cover assembly as claimed in claim 18, wherein further comprising a positioning element and an elastic element configured for elastically resisting the resisting element, the positioning element comprising a panel and two resisting walls, the panel and the two resisting wall cooperatively define a positioning slot where the elastic element is received.
